(19) United States
(12) Patent Application Publication
(10) Pub. No.: US 2005/0003720 A1
(43) Pub. Date: Jan. 6, 2005

(54) Biodegradable nonwovens

(76) Inventor: Frederic Noelle, Saint Nazaire les Eymes (FR)

Correspondence Address: KNOBBE MARTENS OLSON & BEAR LLP, 2040 MAIN STREET, FOURTEENTH FLOOR, IRVINE, CA, 92614, US

(21) Appl. No.: 10/876,507

(22) Filed: Jun. 25, 2004

(30) Foreign Application Priority Data
Jul. 1, 2003 (FR) 03 07946

(51) Int. Cl. B32B 3/00; D04H 3/10

(52) U.S. Cl. 442/59; 442/384; 442/387; 442/389; 442/408; 442/413

(57) ABSTRACT

Nonwoven comprising a core layer made of wood fibres, wherein covering layers comprising continuous polylactic acir or polyvinyl alcohol filaments are applied on both sides of the core layer. The nonwoven is biodegradable.

### BACKGROUND OF THE INVENTION

1. Field of the Invention

The present invention relates to nonwovens and more particularly to biodegradable nonwovens.

2. Description of the Related Art

Biodegradable nonwovens made of viscose or wood fibre viscose are already known. These nonwovens do not have good mechanical strength, nor abrasion resistance, particularly in the wet state, either. They are ill-suited for applications as wipes, dry or wet toilet paper, and other applications of hygiene products.

### SUMMARY OF THE INVENTION

The present invention alleviates this drawback by providing a biodegradable nonwoven that has a mechanical strength and an abrasion resistance that are sufficient for the abovementioned uses, but which however is inexpensive to manufacture.

The nonwoven according to the invention comprises a core layer made of a cellulose material, especially wood fibres, on both sides of which are applied covering layers made of a synthetic or artificial material. The covering layers comprise continuous filaments of polylactic acid (PLA) or polyvinyl alcohol (PVA).

### BRIEF DESCRIPTION OF THE DRAWING

FIG. 1 shows a cross section of one embodiment of a nonwoven in accordance with the invention.

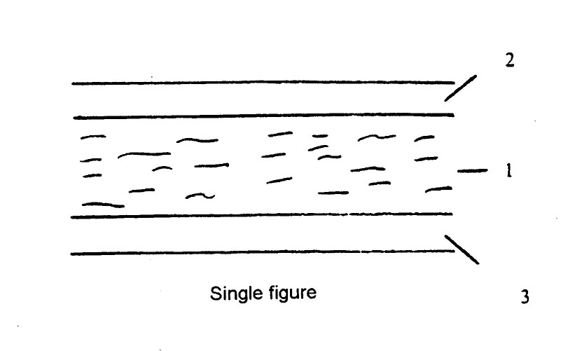

### DETAILED DESCRIPTION OF THE INVENTION

The nonwoven shown in the drawing comprises a core layer 1 made of wood fibres on both sides of which are bonded, by water-jet entanglement, covering layers 2, 3 made of polyvinyl alcohol in this specific embodiment. In this embodiment, the covering layers 2, 3 themselves represent 30% by weight of the nonwoven, and the covering layers are made of continuous polyvinyl alcohol filaments with a filament count of 2 decitex. This nonwoven may be impregnated with a solution, especially an aqueous solution, in which case a preservative is added to the solution in an amount sufficient to prevent bacterial growth. For example, Bronopol may be used as preservative.

Because of the nature of the continuous polylactic acid or polyvinyl alcohol filaments, the covering layers are biodegradable, as is, by its very nature, the wood fibre core. The composite thus obtained is much more biodegradable than a viscose nonwoven. However, since the covering layers consist of continuous filaments, this continuity of material gives mechanical strength, especially tear strength and abrasion resistance, to a point such that it may be possible to be content with a small polylactic acid or polyvinyl alcohol content, which may especially represent less than 50% of the weight of the nonwoven, and preferably less than 30% of this weight.

The core layer is bonded to the covering layers either by calendering or, preferably, by fluid-jet entanglement, or by calendering followed by fluid-jet entanglement, or by fluid-jet entanglement followed by calendering.

Optionally, the nonwoven may have raised or depressed features obtained by calendering or by water-jet entanglement.

Preferably, the covering layers are spun bond webs. The nonwoven has a thickness generally between 0.30 and 1.5 mm and a weight per square metre between 25 g/m² and 100 g/m².

Preferably, the filaments have a filament count between 0.5 and 3 decitex and better still between 0.8 and 2 decitex.

The wood fibres have a length of 2 to 7 mm, preferably 3 to 5 mm.

According to a preferred embodiment, the filaments are made of polyvinyl alcohol of a grade capable of dissolving in water at a temperature of more than 70° C. It is thus possible to convert the nonwoven into a liquid waste, this being easier to get rid of than solid waste. The nonwoven is dispersible in hot water, the wood fibres, after the polyvinyl alcohol that holds them together has been dissolved, in turn dispersing in the water. A preservative may be placed in the packaging for the nonwoven, or it may be added to an aqueous solution for impregnating the nonwoven. The solution may represent from 50 to 800% by weight of the dry nonwoven.

In particular, the nonwoven has a thickness between 0.4 mm and 1 mm and a symmetrical structure, the core layer having, for example, a thickness of between 0.25 and 0.7 mm.

1. Nonwoven comprising a core layer made of wood fibres, wherein covering layers comprising continuous polylactic acid or polyvinyl alcohol filaments are applied on both sides of the core layer.

2. Nonwoven according to claim 1, wherein the covering layers represent less than 50% of the weight of the nonwoven.

3. Nonwoven according to claim 2, wherein the layers are bonded together by fluid-jet entanglement, or by calendering, or by calendering followed by fluid-jet entanglement, or by fluid-jet entanglement followed by calendering.

4. Nonwoven according to claim 1, wherein the filaments have a filament count between 0.5 and 3 decitex.

5. Nonwoven according to claim 1, wherein it is impregnated with an aqueous solution.

6. Nonwoven according to claim 5, wherein the aqueous solution represents from 50 to 800% of the weight of the dry nonwoven.

7. Nonwoven according to claim 1, packaged in a packaging, wherein a preservative is placed in the packaging.

8. Nonwoven according to claim 1, wherein the covering layers comprise continuous polylactic acid or polyvinyl alcohol filaments.
